(19) United States
(12) Patent Application Publication
(10) Pub. No.: US 2024/0405820 A1
(43) Pub. Date: Dec. 5, 2024

(54) CODEBOOK DESIGN METHOD AND DEVICE IN A WIRELESS COMMUNICATION SYSTEM

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Gene Back Hahn, Hwaseong-si (KR); Young Kil Suh, Hwaseong-si (KR); Ui Hyun Hong, Hwaseong-si (KR); Bum Jun Kim, Seoul (KR); Jeonghyeon Kwon, Seoul (KR); Wan Choi, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/793,456

(22) Filed: Aug. 2, 2024

Related U.S. Application Data
(63) Continuation of application No. PCT/KR2023/001595, filed on Feb. 3, 2023.

(30) Foreign Application Priority Data
Feb. 4, 2022 (KR) 10-2022-0015052

(51) Int. Cl. H04B 7/06

(52) U.S. Cl. CPC H04B 7/0617; H04B 7/0626

(57) ABSTRACT

A method for a first communication node may include calculating a time delay value on the basis of a carrier frequency based on the number of antenna panels, the number of antennas of each antenna panel, and a space layer that can be generated using a plurality of antennas. The method may also include generating a frequency-dependent first phase shift matrix (PSM) according to each subcarrier by using the calculated time delay value. The method may also include multiplying the first PSM by a basic codebook so as to generate a first codebook for compensating for a beam squint of a beam generated through each antenna.

### CROSS-REFERENCE TO RELATED APPLICATIONS

This application is a continuation of International Application No. PCT/KR2023/001595 filed on Feb. 3, 2023, which claims priority to and the benefit of Korean Patent Application No. 10-2022-0015052, filed on Feb. 4, 2022, the entire disclosures of each of which are incorporated herein by reference.

### TECHNICAL FIELD

The present disclosure relates to codebook design in a wireless communication system, and more particularly, to codebook design in a wireless communication system of a high frequency band.

### BACKGROUND

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios, such as terrestrial communication, non-terrestrial communication, sidelink communication, and the like.

Meanwhile, the 5G NR communication standard defines Type 1 codebook and Type 2 codebook to support multi-antenna transmission.

The Type 1 codebook defined in the 5G NR communication standard is constructed with the same logic as the LTE codebook and is represented in a slightly more complex and diverse form of matrices than in LTE. The Type 1 codebook is designed through a process of determining a beam to be used and a co-phase coefficient.

The Type 2 codebook defined in the 5G NR communication standard does not rely on pre-designed tables like the Type 1 codebook, but instead utilizes many parameters and is determined through a more complex scheme compared to the Type 1 codebook, allowing for the design of more sophisticated precoding matrices. The Type 2 codebook is designed through a process of determining multiple beams to be used and an amplitude scaling and a phase coefficient for each beam, which is expressed in a form of a linear combination.

However, because the codebook defined in the 5G NR standard takes into account a relatively small number of antenna panels and layers, it is difficult to be applied directly to 6G terahertz wireless communication, which considers a large number of antennas and communication devices. In addition, 6G terahertz communication is expected to utilize a much larger number of antennas and a wider frequency band than before. Therefore, the codebook designed in the existing 5G NR standard cannot address phenomena occurring in 6G terahertz wireless communication. Thus, the development of new communication techniques that consider 6G terahertz wireless communication is necessary.

The subject matter described in this background section is intended to promote an understanding of the background of the disclosure and thus may include subject matter that is not already known to those of ordinary skill in the art.

### SUMMARY

The present disclosure is directed to a method and an apparatus for generating a codebook suitable for a wireless communication system that utilizes a significantly large number of antennas and a wider frequency band than before.

The present disclosure is also directed to a scheme of updating and utilizing a codebook and a signaling procedure therefor.

A method of a first communication node according to the present disclosure may include, based on a number of antenna panels, a number of antennas in each antenna panel, and spatial layers configurable using a plurality of antennas, calculating time delay values based on a carrier frequency. The method may further include generating first frequency-dependent phase shift matrices (PSMs) for respective subcarriers using the calculated time delay values. The method may further include generating a first codebook compensating for a beam squint phenomenon of beams generated by the plurality of antennas by multiplying matrices of a basic codebook with the first PSMs.

The first PSM may include a phase compensation value for each spatial layer transmitted for each subcarrier.

The basic codebook may be one of codebooks generated without considering the beam squint phenomenon.

Each of the antenna panels may have a Uniform Linear Array (ULA) structure or a Uniform Planar Array (UPA) structure.

Another method of a first communication node according to the present disclosure may include mapping combination indexes to antenna panels and spatial layers configurable using a plurality of antennas. The method may further include transmitting mapping information for the combination indexes to a second communication node. The method may further include transmitting a time delay reference signal (TD-RS) to the second communication node based on a frequency-domain density according to a subcarrier spacing (SCS). The method may also include receiving time delay values for respective subcarriers, which are respectively mapped to the spatial layers and the antenna panels, from the second communication node. The method may further include generating second frequency-dependent second phase shift matrices (PSMs) based on the received time delay values. The method may further include generating a second codebook compensating for a beam squint phenomenon of beams generated by the plurality of antennas by multiplying matrices of a basic codebook with the second PSMs.

The second PSM may include a phase compensation value for each spatial layer transmitted for each subcarrier.

The basic codebook may be one of codebooks generated without considering beam squint phenomenon.

The mapping information for the combination indexes for the spatial layers and the antenna panels may be transmitted to the second communication node through higher layer signaling or a system information block (SIB).

The time delay values may be received as being included in a channel state information (CSI) report.

In the generating of the frequency-dependent second PSMs, a time delay value for a subcarrier in which the TD-RS is not transmitted may be calculated based on interpolation using time delay values of closest subcarriers among subcarriers in which the TD-RS is transmitted.

The method may further include transmitting data to the second node using the second communication codebook.

The method may further include transmitting the TD-RS to the second communication node when re-generation of the second PSMs is requested from the second communication node. The method may further include re-receiving time delay values for the respective subcarriers, which respectively are mapped to the spatial layers and the antenna panels, from the second communication node. The method may further include re-generating frequency-dependent second PSMs based on the re-received time delay values. The method may further include re-generating a second codebook using the re-generated second PSMs.

A first communication node according to embodiments of the present disclosure may include at least one processor. The at least one processor causes the first communication node to perform mapping combination indexes to antenna panels and spatial layers configurable using a plurality of antennas, and transmitting mapping information for the combination indexes to a second communication node. The at least one processor further causes the first communication node to perform transmitting a time delay reference signal (TD-RS) to the second communication node based on a frequency-domain density according to a subcarrier spacing (SCS). The at least one processor further causes the first communication node to perform receiving time delay values for respective subcarriers, which are respectively mapped to the spatial layers and the antenna panels, from the second communication node. The at least one processor further causes the first communication node to perform generating second frequency-dependent second phase shift matrices (PSMs) based on the received time delay values. The at least one processor further causes the first communication node to perform generating a second codebook compensating for a beam squint phenomenon of beams generated by the plurality of antennas by multiplying matrices of a basic codebook with the second PSMs.

The second PSM may include a phase compensation value for each spatial layer transmitted for each subcarrier.

The basic codebook may be one of codebooks generated without considering beam squint phenomenon.

The mapping information for the combination indexes for the spatial layers and the antenna panels may be transmitted to the second communication node through higher layer signaling or a system information block (SIB).

The time delay values may be received as being included in a channel state information (CSI) report.

In the generating of the frequency-dependent second PSMs, the processor may cause the first communication node to perform: calculating a time delay value for a subcarrier in which the TD-RS is not transmitted based on interpolation using time delay values of closest subcarriers among subcarriers in which the TD-RS is transmitted.

The at least one processor may further cause the first communication node to perform: transmitting data to the second node using the second communication codebook. The at least one processor may further cause the first communication node to perform transmitting the TD-RS to the second communication node when re-generation of the second PSMs is requested from the second communication node. The at least one processor may further cause the first communication node to perform re-receiving time delay values for the respective subcarriers, which respectively are mapped to the spatial layers and the antenna panels, from the second communication node. The at least one processor may further cause the first communication node to perform re-generating frequency-dependent second PSMs based on the re-received time delay values. The at least one processor may further cause the first communication node to perform re-generating a second codebook using the re-generated second PSMs.

By applying the apparatuses and methods described in the present disclosure, it is possible to generate a codebook suitable for wireless communication systems that utilize a very large number of antennas and a wider frequency band than before. The generated codebook can be used to achieve more reliable data transmission.

### DESCRIPTION OF DRAWINGS

FIG. 1 is a conceptual diagram illustrating an embodiment of a communication system.

FIG. 2 is a block diagram illustrating an embodiment of a communication node constituting a communication system.

FIG. 3A is a conceptual diagram for describing a beam squint phenomenon when a base station transmits beams using multiple antennas.

FIG. 3B is a diagram for describing phases of desired beams and beams affected by a beam squint phenomenon.

FIG. 4 is a diagram illustrating a partial configuration of a base station transceiver according to the present disclosure.

FIG. 5 is a control flow diagram for a case of generating the first codebook according to an embodiment of the present disclosure.

FIG. 6 is a control flow diagram for a case of generating the second codebook according to another embodiment of the present disclosure.

FIG. 7 is a conceptual diagram illustrating a procedure for generating a codebook considering beam squint phenomenon and communicating using the codebook in a wireless communication system according to an embodiment of the present disclosure.

### DETAILED DESCRIPTION

Because the present disclosure may be variously modified and have several forms, specific embodiments are shown in the accompanying drawings and described in detail in the detailed description. It should be understood, however, that it is not intended to limit the present disclosure to the specific embodiments. On the contrary, the present disclosure is intended to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named as a second component without departing from the scope of the present disclosure, and the second component may also be similarly named as the first component. The term “and/or” means any one or a combination of a plurality of related and described items.

When it is mentioned that a certain component is “coupled with” or “connected with” another component, it should be understood that the certain component is directly “coupled with” or “connected with” to the other component, or a further component may be disposed therebetween. In contrast, when it is mentioned that a certain component is “directly coupled with” or “directly connected with” another component, it should be understood that a further component is not disposed therebetween.

The terms used in the present disclosure are only used to describe specific embodiments and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists. However, it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which the present disclosure belongs. Terms that are generally used and have been in dictionaries should be construed as having meanings matched with contextual meanings in the art. In the present disclosure, unless defined clearly, terms are not necessarily construed as having formal meanings. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

A communication system to which embodiments according to the present disclosure are applied is described. The communication system to which the embodiments according to the present disclosure are applied is not limited to the contents described below, and the embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like. The terminal may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multi-hop relay (MMR)-BS, or the like. The base station may include all or part of functions of the base station, access point, radio access station, NB, eNB, base transceiver station, MMR-BS, or the like.

Hereinafter, embodiments of the present disclosure are described in more detail with reference to the accompanying drawings. In describing the present disclosure, in order to facilitate an overall understanding, the same reference numerals are used for the same or equivalent elements in the drawings, and redundant descriptions for the same elements are omitted.

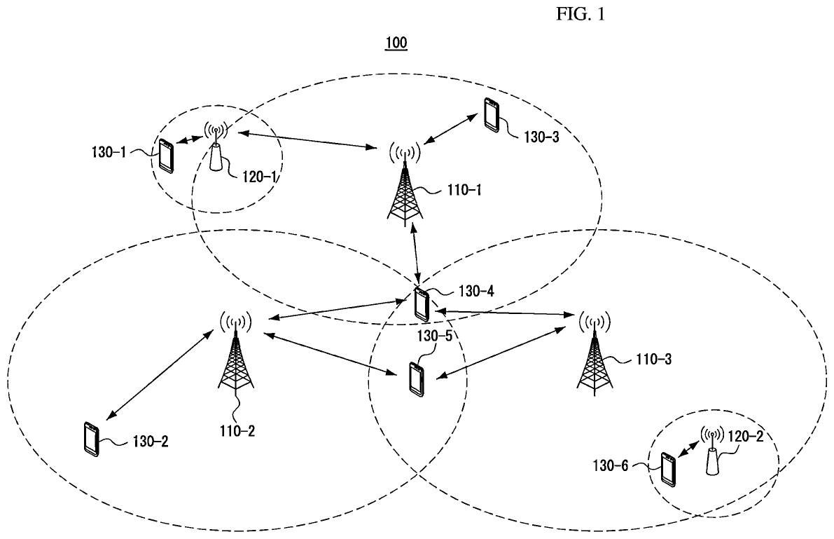

FIG. 1 is a conceptual diagram illustrating an embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further include a core network (e.g., a serving gateway (S-GW), a packet data network (PDN) gateway (P-GW), a mobility management entity (MME). When the communication system 100 is a 5G communication (e.g., New Radio (NR) system), the core network may include an access and mobility management function (AMF), a user plane function (UPF), a session management function (SMF), and the like.

The plurality of communication nodes 110-1, 110-2, 110-3, 120-1, 120-2, 130-1, 130-2, 130-3, 130-4, 130-5, and 130-6 may support communication protocols (e.g., LTE communication protocol, LTE-A communication protocol, NR communication protocol, etc.) specified in 3^{rd} generation partnership project (3GPP) standards. The plurality of communication nodes 110-1, 110-2, 110-3, 120-1, 120-2, 130-1, 130-2, 130-3, 130-4, 130-5, and 130-6 may support a code division multiple access (CDMA) technique, a wideband CDMA (WCDMA) technique, a time division multiple access (TDMA) technique, a frequency division multiple access (FDMA) technique, an orthogonal frequency division multiplexing (OFDM) technique, a filtered OFDM technique, a cyclic prefix OFDM (CP-OFDM) technique, a discrete Fourier transform spread OFDM (DFT-s-OFDM) technique, an orthogonal frequency division multiple access (OFDMA) technique, a single carrier FDMA (SC-FDMA) technique, a non-orthogonal multiple access (NOMA) technique, a generalized frequency division multiplexing (GFDM) technique, a filter bank multi-carrier (FBMC) technique, a universal filtered multi-carrier (UFMC) technique, a space division multiple access (SDMA) technique, or the like. Each of the plurality of communication node may have the following structure.

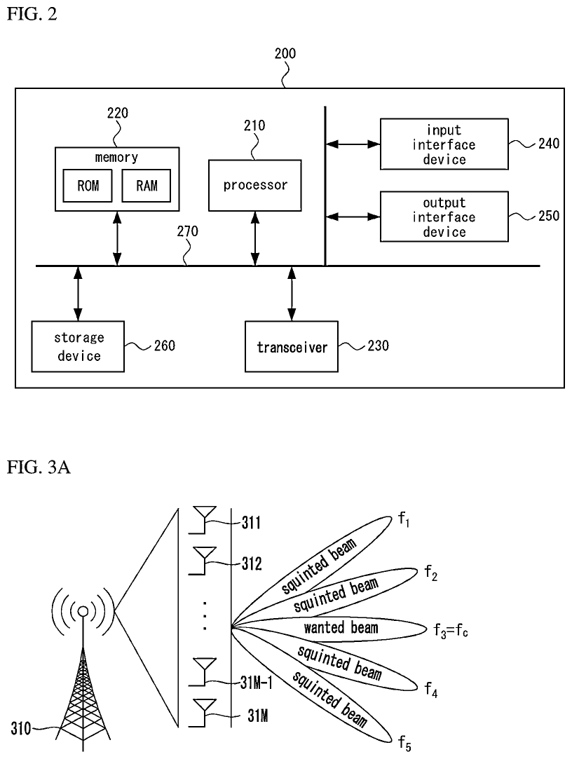

FIG. 2 is a block diagram illustrating an embodiment of a communication node constituting a communication system.

As shown in FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other and may be connected to each other through a bus 270.

The processor 210 may execute a program stored in at least one of the memory 220 or the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium or a non-volatile storage medium. For example, the memory 220 may comprise at least one of read-only memory (ROM) or random access memory (RAM).

Referring again to FIG. 1, the communication system 100 may comprise a plurality of base stations 110-1, 110-2, 110-3, 120-1, and 120-2 and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), gNB, advanced base station (ABS), high reliability-base station (HR-BS), base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul and may exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6 and may transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 and may perform operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6, which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for transmitting and receiving signals in a communication system are described. Even when a method (e.g., transmission or reception of a signal) performed at a first communication node among communication nodes is described, the corresponding second communication node may perform a method (e.g., reception or transmission of the signal) corresponding to the method performed at the first communication node. In other words, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in order to process rapidly increasing wireless data, 5G (or NR) communication or later wireless communication technologies can support communication in a relatively high frequency band. For example, radio frequency bands used for wireless communication in the 5G (or NR) communication standard may be largely divided into frequency range 1 (FR1) bands and frequency range 2 (FR2) bands. Here, the FR1 bands may refer to frequency bands of approximately 7 GHz or below, which may mean relatively low frequency bands compared to the FR2 bands. The FR2 bands may refer to relatively high frequency bands compared to the FR1 bands, exceeding about 7 GHz. The FR2 band specified in 3GPP NR is a band of 28 to 29 GHz and may include unlicensed band, mmWave band, and terahertz band.

In addition, in 5G (or NR), a carrier bandwidth is defined as up to 100 MHz in FR1 and up to 400 MHz in FR2. Because 5G (or NR) requires a further increase in carrier bandwidth compared to the maximum bandwidth (20 MHz) supported by LTE, there is a possibility that a terminal may not be able to support the entire carrier bandwidth of up to 400 MHz depending on a power and computing capability of the terminal. Therefore, in the 5G (or NR) standard, some continuous resource blocks (RBs) within a carrier bandwidth may be defined and used as a bandwidth part (BWP). The BWP may be defined to have a different center frequency, bandwidth, and numerology for each terminal, and one terminal may activate only one BWP within a single carrier bandwidth.

BWPs may be freely defined within the carrier bandwidth, and furthermore, an activated BWP may be switched and used as services required by the terminal vary. A scheme of using BWPs while switching between them as described above may be referred to as ‘BWP adaptation’. The current 5G standard specifies a method of increasing scheduling flexibility by shifting a center frequency through BWP adaptation, a method of increasing a bandwidth to transmit a larger amount of data, or a method of changing a numerology to select a subcarrier spacing (SCS) suitable for the current services.

Describing additionally the contents defined in the current 5G (or NR) standard, one frame used when communicating within a BWP may consist of or comprise two half-frames of 5 ms each, and each half-frame may consist of or comprise subframes of 1 ms each. Therefore, there are a total of 10 subframes within one frame. In addition, one subframe may consist of or comprise one or multiple slots according to an SCS. For example, one subframe may consist of or comprise one slot if the SCS is 15 KHz, may consist of or comprise two slots if the SCS is 30 KHz, and may consist of or comprise four slots if the SCS is 60 KHz. In this case, each slot may consist of or comprise 14 symbols if a normal cyclic prefix (CP) is used.

As described above, the 5G (or NR) supports various SCSs, and each BWP may have a different SCS within the same bandwidth depending on a type of the BWP. Because there are different SCSs depending on the types of BWP, a reference coordinate that specifies a location of each resource block is required, which is referred to as ‘Point A’. In other words, the Point A is used to designate a specific reference resource block within the corresponding BWP.

Hereinafter, codebook-related matters in 5G (or NR) are described briefly. The 5G standard defines phase-tracking reference signals (PT-RS or PTRS) due to the use of high frequency bands. The PTRS may be used in each of receivers and transmitters to track a phase of a local oscillator. This suppresses phase noise and common phase error, which are particularly important at high carrier frequencies such as millimeter waves. Due to the nature of phase noise, the PTRS may have low density in the frequency domain but high density in the time domain. The PTRS may exist in both downlink (e.g., PDSCH) and uplink (e.g., PUSCH). When the PTRS is transmitted, the PTRS is always associated with one DMRS port and is limited by a reserved bandwidth and duration of a PDSCH/PUSCH. The time-domain and frequency-domain densities of PTRS may be adjusted according to a signal to noise ratio (SNR) and a scheduling bandwidth.

Meanwhile, 5G (or NR) defines precoding matrix indicator (PMI). The PMI may be configured to a UE by higher layer parameters or may be provided to a UE based on signaling information such as DCI. The UE may measure and report information on a PMI to the base station (e.g., gNB). However, the base station may or may not use the PMI reported by the UE. From the base station's perspective, the UE may be indicated to use a specific PMI. In this case, the UE may need to use a specific precoding matrix specified by the base station.

Furthermore, a codebook may be understood as a set of precoding matrices. In other words, a codebook may be regarded as a set of matrices with complex-valued elements that transform data bits of a PDSCH into another data set mapped to respective antenna ports. The codebook may be classified into a codebook for a case where the base station has a single panel and a codebook for a case where the base station has a multi-panel. The codebook may be configured in relation to the antenna ports. In addition, in the 5G standard, the Type I codebook is classified as a codebook for the multi-panel case.

In other words, 5G supports the Type 1 codebook, Type 2 codebook, and enhanced Type 2 codebook for multi-antenna transmission. The Type 1 codebook, Type 2 codebook, or enhanced Type 2 codebook may be determined depending on the number of terminals supported by given time/frequency resources, and even within the same type, the codebook design varies depending on the number of antenna panels.

However, in the current 5G standard, although there are differences depending on the codebook, the Type 1 single-panel codebook supports up to 8 layers, the Type 1 multi-panel codebook supports up to 8 antenna panels, and up to four layers are considered for each panel. Therefore, it is difficult to support ultra-massive Machine-Type Communications (umMTC) and extremely reliable and low-latency communications (ERLLC), which are the goals of 6G terahertz wireless communications.

The 6G terahertz wireless communication is expected to utilize more antennas and wider frequency bands. This may cause a beam squint phenomenon where a difference in propagation delay between antennas becomes larger and a shift in spatial direction observed for each subcarrier increases.

However, the codebook design scheme defined in the current 5G standard cannot solve the beam squint phenomenon that occurs with a very large number of antennas and a very wide frequency band. Therefore, a new codebook design technique considering 6G terahertz communication systems is needed. The present disclosure described below proposes codebook design and/or generation techniques considering 6G terahertz communication systems, particularly addressing the beam squint phenomenon. Additionally, the present disclosure proposes configuration and signaling methods for parameters required to prevent the beam squint phenomenon in 6G terahertz communication systems.

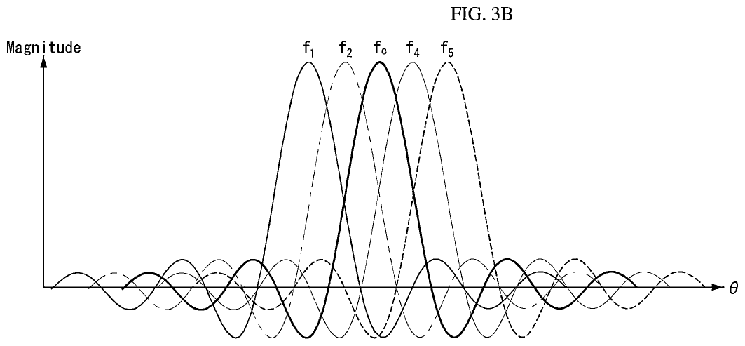

FIG. 3A is a conceptual diagram for describing a beam squint phenomenon when a base station transmits beams using multiple antennas, and FIG. 3B is a diagram for describing phases of desired beams and beams affected by a beam squint phenomenon.

As shown in FIG. 3A, a case is illustrated in which a base station 310 wishes to transmit signals in a specific frequency band f_{c} through a plurality of antennas 311, 312, . . . , 31M-1, and 31M. For convenience of description, FIG. 3A illustrates a case where the plurality of antennas 311, 312, . . . , 31M-1, and 31M are included in a single panel of a uniform linear array (ULA) structure.

If the wireless communication system utilizes a wider frequency band than before, such as an unlicensed band of millimeter waves or a terahertz frequency band, a much larger number of antennas may be used than before. As a distance between the antennas within the antenna structure gradually increases due to the increased number of antennas, a difference in propagation delay between the respective antennas may become larger.

In general, a time delay may be a linear phase shift with respect to a frequency. In addition, beamforming may form a beam to a specific direction (i.e., desired beam direction) through a specific phase shift. Such phase shift may be translated into a frequency function. Describing this again, the phase shift with respect to the desired beam direction may be expressed as a frequency function.

In this case, as a frequency band allocated to the wireless communication system becomes wider, a difference between a frequency allocated to each subcarrier and a center frequency may increase. The existing beamforming process is performed for the center frequency rather than the frequencies allocated to the respective subcarriers. Therefore, when the existing beamforming process is used in a wide frequency band such as the terahertz frequency band, an error may occur in alignment direction due to per-subcarrier frequency errors. This may result in the phenomenon of performing beamforming in different directions for the respective subcarrier frequencies.

In the present disclosure, the phenomenon in which a difference in propagation delay occurs between antennas, resulting in a slight shift in beam direction depending on the locations of the antennas and the locations of wideband subcarriers, may be defined as a beam squint phenomenon.

Accordingly, the phase shifts according to the propagation delays may result in the formation of squinted beams f₁, f₂, f₄, and f₃ based on the desired beam (f₃=f_{c}) and the propagation delays, as illustrated in FIG. 3A. As a result, as illustrated in FIG. 3A, shifts in spatial directions between subcarriers existing within the same frequency band may occur.

As shown in FIG. 3B, a relationship between amplitudes and phases of the beam f₃=f_{c} and the squinted beams f₁, f₂, f₄, and f₃ is illustrated. Therefore, it is possible to accurately measure the propagation delays, i.e., time delays, and compensate for phases based on the measured time delays. Thus, squinted beams may be prevented from occurring.

In the present disclosure described below, a codebook may be designed using the following three methods.

First, frequency-dependent phase shift matrices (PSMs) using time delay values may be calculated through mathematical equation(s), and a codebook considering the beam squint phenomenon may be designed based on the calculated PSMs.

Second, the terminal may measure and report time delay values through transmission and reception of reference signals, frequency-dependent PSMs may be derived based on the information reported by the terminal, and a codebook may be designed based on the derived PSMs.

Third, PSMs may be calculated using the first method, a first codebook may be designed using the calculated PSMs, and communication may be performed using the first codebook. Then, PSMs may be derived using the second method, and a second codebook may be designed using the derived PSMs. In addition, if errors increase during communication based on the second codebook according to the second method, the second codebook may be further modified using the second method again.

By deriving the frequency-dependent PSMs using one of the above three methods and then multiplying them by the existing codebook matrices, the first codebook and/or second codebook or modified second codebook may be generated, and these codebooks can compensate for the difference in propagation delay between the antennas and the phase shift between the respective subcarriers.

While communicating with a terminal using the first codebook and/or the second codebook, the base station may be unable to use the codebook(s) being used for communication due to changes in channel conditions due to various factors. If the codebook being used for communication cannot be used or is determined to be unusable, a PSM reconstruction process may be performed to derive (or calculate) PSMs again.

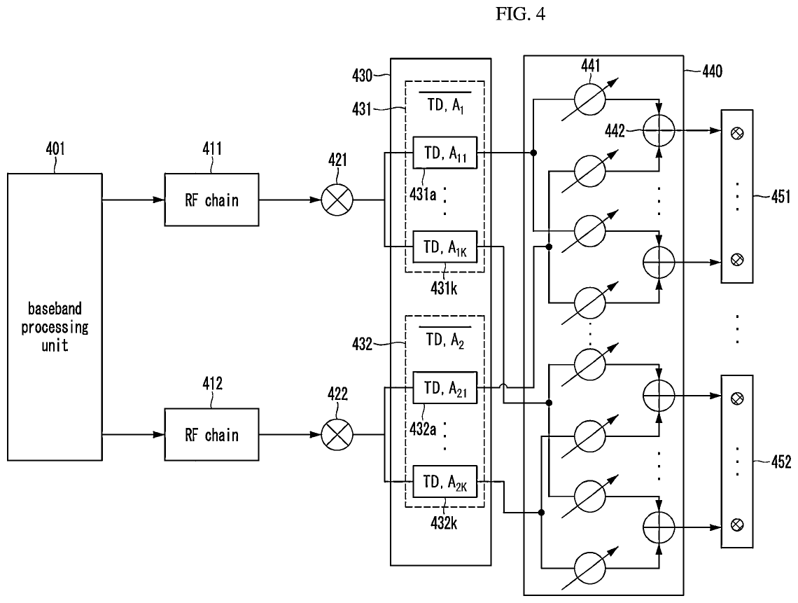

FIG. 4 is a diagram illustrating a partial configuration of a base station transceiver according to the present disclosure.

The base station transceiver is a part of the transceiver 230 previously described in FIG. 2 and may be a part of a transmitter for transmitting data.

As shown in FIG. 4, a baseband processing unit 401, RF chains 411 and 412, mixers 421 and 422, a time delay calculation unit 430, a phase shift unit 440, and a plurality of antenna panels 451 and 452.

First, the baseband processing unit 401 may process baseband data (or signal or channel) to be transmitted and then output it. The baseband processing unit 401 may encode and modulate data to be transmitted in accordance with the wireless communication standard of the communication system (e.g., technical specifications of the 5G system). Then, the baseband processing unit 401 may output the data to be transmitted at a transmission time by mapping the data to an appropriate channel.

The RF chains 411 and 412 may each include an amplifier, a filter, and the like. In FIG. 4, only two RF chains 411 and 412 are illustrated due to drawing limitations, but the number of RF chains is not limited to two. In other words, it is possible to have a greater number of RF chains than the example of FIG. 4, and those having ordinary skill in the art can understand that the number of RF chains is not limited to two. The RF chains 411 and 412 may perform processing such as amplifying and filtering data to be transmitted. The RF chains 411 and 412 may amplify signals received from the baseband processing unit 401, may perform processing such as filtering to remove noise generated during amplification, and may output the signals.

In FIG. 4, two mixers 421 and 422 are illustrated, but this is due to drawing limitations, and as with the RF chains described above, those having ordinary skill in the art can understand that a plurality of mixers may be included. The mixers 421 and 422 may up-convert the data output from the RF chains to a frequency band according to communication standards by mixing the output data with a carrier frequency. For example, in case of 5G wireless communication, the output of the RF chains 411 and 412 may be up-converted to at least one of the bands (FR1 and FR2) used in 5G communication, and in case of 6G wireless communication, the output of the RF chains 411 and 412 may be up-converted to a band used in 6G communication. The mixers 421 and 422 according to the present disclosure may up-convert to the FR2 band, which is a higher band among 5G bands, or to the terahertz band in the 6G wireless communication system. However, the mixers 421 and 422 according to the present disclosure should not be interpreted as being limited to the case of up-conversion to such the high frequency bands in 5G and 6G.

The time delay calculation unit 430 may include a first time delay calculation group 431 for calculating and compensating for time delays of the data output from the first mixer 421 and a second time delay calculation group 432 for calculating and compensating for time delays of the data output from the second mixer 422. FIG. 4 illustrates the first time delay calculation group 431 and the second time delay calculation group 432 as an example, and more or fewer time delay calculation groups may be included in the time delay calculation unit 430. The first time delay calculation group 431 may include a plurality of time delay calculators 431a, . . . , and 431k, and the second time delay calculation group 432 may include a plurality of time delay calculators 432a, . . . , and 432k. Each of the time delay calculators 431a, . . . , 431k, 432a, . . . , and 432k may calculate a time delay occurring between an antenna panel and an antenna element of the antenna panel. In addition, each of the time delay calculators 431a, . . . , 431k, 432a, . . . , and 432k may calculate and compensate for time delays of data transmitted according to the present disclosure.

The phase shift unit 440 may include a plurality of phase shifters 441, and the phase shifters may output data obtained from the time delay calculation unit 430 by shifting phases of the data in a manner according to the present disclosure described below. In addition, the phase shift unit 440 may include an adder 442 that adds inputs from two different phase shifters. Each adder included in the phase shift unit 440 may output data to antenna element(s) of a specific panel.

Each of the plurality of antenna panels 451 and 452 may include a preset number of antenna elements. For example, if K antenna panels exist, each antenna panel may have P antenna elements. Here, each antenna element may correspond to one antenna. In addition, FIG. 4 illustrates a case of ULA antenna, but the present disclosure may also be applied to a case of uniform planar array (UPA) antenna. It should be noted that the ULA type antenna illustrated in FIG. 4 is merely an example for convenience of description.

The configuration of FIG. 4 described above uses the base station as an example. However, the configuration of FIG. 4 may be applied equally or similarly to a mobile terminal, such as user equipment (UE), that communicates with the base station. If the UE has multiple antenna panels, the same form as in FIG. 4 may be applied. As another example, if the UE has a single panel comprising antennas, it is possible to implement a form where the outputs toward the respective antennas are directly controlled without being divided into panels as described in FIG. 4.

The three embodiments previously described in the present disclosure are described using the example of FIG. 4 described above.

In the mobile communication systems, a scheme of communicating by distinguishing spatial layers has been used since the LTE system uses Multiple Input Multiple Output (MIMO) antenna techniques. The scheme of distinguishing spatial layers corresponds to a method that can increase a data transmission rate by allowing multiple data streams to be transmitted using a MIMO antenna technique through the same wireless channel in a multi-path propagation environment between a transmitter and a receiver. Such spatial layer division multiplexing is not only used in the 5G mobile communication system but will also be used in the 6G mobile communication system to be developed in the future.

In the present disclosure, a method of theoretically calculating a time delay value for each antenna panel and each spatial layer is described.

Before describing operations according to the present disclosure, it should be noted that operations described below may be operations performed between a transmitting node and a receiving node. Therefore, the transmitting node may be a base station or UE. If the transmitting node is a base station, the receiving node may be a UE. On the other hand, if the transmitting node is a UE, the receiving node may be a base station or another UE. For convenience of description, the following description assumes that the transmitting node is a base station and the receiving node is a UE.

When using a large number of antennas and a wide frequency band such as a terahertz band, a difference in propagation delays observed for the respective panels may occur, and a shift in spatial directions observed for the respective subcarriers may occur. Accordingly, the base station may need to calculate time delay values to compensate for a beam squint phenomenon caused by the propagation delays and the spatial direction shifts. The time delay values may be calculated in the time delay calculation unit 430 of FIG. 4. As another example, the time delay values may be calculated by the processor 210 illustrated in FIG. 2 and provided to the time delay calculation unit 430. As another example, the time delay values may be previously stored in the memory 220 and/or the storage device 260 based on a calculation equation described below. The time delay values for the respective panels, which correspond to the respective spatial layers, may be calculated and/or stored as shown in Table 1 below.

TABLE 1

| Spatial layer | Panel | Time delay value |
|---|---|---|
| L #1 | Panel #1 | TD, A_{1, 1} |
| | Panel #2 | TD, A_{1, 2} |
| | Panel #3 | TD, A_{1, 3} |
| L #2 | Panel #1 | TD, A_{2, 1} |
| | Panel #2 | TD, A_{2, 2} |
| | Panel #3 | TD, A_{2, 3} |

Table 1 illustrates a case with two spatial layers and three antenna panels. However, four or more spatial layers may exist. In addition, the number of antenna panels may be three or more. It should be noted that Table 1 is merely one example illustrating the case with two spatial layers and three antenna panels.

When calculating the time delay values based on the equation in the ULA antenna structure as illustrated in FIG. 4, the time delay of each spatial layer and the panel corresponding to the spatial layer may be calculated as in Equation 1.

$$TD , {A}_{X , Y} = \{ \begin{matrix}( K - 1 + Y ) [ - \frac{P {θ}_{c , X}}{2} ] {T}_{c} , & {θ}_{c , X} > 0 \\ Y [ - \frac{P {θ}_{c , X}}{2} ] {T}_{c} , & {θ}_{c , X} \leq 0\end{matrix} \qquad [ Equation 1 ]$$

In Equation 1, K denotes the number of antenna panels, P denotes the number of antennas elements present in each antenna panel, and T_{c} denotes a period with respect to a center frequency f_{c}, i.e., the reciprocal of the center frequency. In addition, X denotes a spatial layer index of each spatial layer, and Y denotes an antenna panel index of each antennal panel. Because X is an index of a spatial layer constituting a codebook, it may be interpreted as an index of a beam implemented through the codebook. When X is interpreted as an index of a beam implemented through the codebook as described above, θ_{c,X} may correspond to a spatial direction observed at the center frequency f_{c} through the X-th beam (i.e. L #X). Here, the X-th beam (i.e., L #X) may be understood as the X-th spatial layer (i.e. L #X). Here, the center frequency f_{c} may be a carrier frequency.

Equation 1 above outputs a theoretical time delay value assuming the case of ULA, and even in other standardized antenna structures (e.g., UPA) where antennas are installed at regular intervals like ULA, the theoretical time delay value can be calculated by using the antenna index and spatial layer index. Therefore, in Table 1, TD, A_{X,Y} may refer to a theoretical time delay value when the X-th beam (L #X) is transmitted through the Y-th antenna panel (i.e., antenna panel #Y), which is calculated through Equation 1.

The reason why calculations are possible in the structure of ULA or UPA as described above is because a distance between antenna panels and a distance between antenna elements (one antenna element corresponds to one antenna) within one panel are uniformly predetermined. Therefore, if the distance between antenna elements is non-uniform or the distance between antenna panels is uneven, the equation described above cannot be applied as is. However, if the base station knows the exact distances even if the distance between antenna elements and the distance between antenna panels are non-uniform, calculation may be possible through modification of the equation.

In the second or third embodiment described above, the terminal may measure and report the time delay values based on transmission and reception of reference signals, and the frequency-dependent PSMs are derived based on the information reported by the terminal. Using the theoretical time delay values calculated as in Table 1, the frequency-dependent PSMs may be expressed as shown in Table 2 below.

TABLE 2

| PSM | Subcarrier | Matrix |
|---|---|---|
| PSM | SC #1 | diag([exp(−j2π(SC #1) [symbol] ), |
| #1 | | exp(−j2π(SC #1) [symbol] )]) |
| PSM | SC #2 | diag([exp(−j2π(SC #2) [symbol] ), |
| #2 | | exp(−j2π(SC #2) [symbol] )]) |
| . . . | . . . | . . . |
| PSM | SC #120 | diag([exp(−j2π(SC #120) [symbol] ), |
| #120 | | exp(−j2π(SC #120) [symbol] [symbol] |

[symbol]

indicates data missing or illegible when filed

In Table 2, PSM #Z represents a PSM for the Z-th subcarrier, and diagonal components of each PSM include phase compensation values considering the frequency of the Z-th subcarrier, the corresponding spatial layer, and the time delays for the respective antenna panels.

Table 2 may have a form in which PSMs for all subcarriers within a frequency band are calculated based on different time delay values for the respective spatial layers and antenna panels, which are calculated in Table 1 described above. For example, Table 2 is an example for a case where there are 120 subcarriers in the frequency band, and PSM #1 to PSM #120 illustrate PSMs calculated as PSMs for the first subcarrier (SC #1) to the 120-th subcarrier (SC #120).

The diagonal components of PSM #Z may be expressed as Equation 2 below.

$$exp ( - j 2 π ( SC \# Z ) {\vec{TD , A}}_{X} ) \qquad [ Equation 2 ]$$

Equation 2 means a phase compensation value for the SC #Z and the X-th spatial layer (L #X). Here, the SC #Z may mean the frequency of the Z-th subcarrier in the allocated frequency band.

In Table 2, the theoretical time delay values for all antenna panels corresponding to the X-th spatial layer (L #X) may be expressed as Equation 3 below.

$${\vec{TD , A}}_{X} = {[ TD , {A}_{X , 1} TD , {A}_{X , 2} … TD , {A}_{X , K} ]}^{T} \qquad [ Equation 3 ]$$

In Equation 3, [·]^{T} means a transpose operation.

Since the present disclosure illustrates the case with three antenna panels as described in Table 1, K may be assumed to be 3. However, it is apparent to those having ordinary skill in the art that the present disclosure is not limited to three antenna panels, and the present disclosure may be equally applied to a case of having four or more antenna panels based on the above-described contents and methods described below. However, for convenience of description, the following description is made assuming that there are three antenna panels.

The base station may use the PSMs obtained as shown in Table 2 to design a codebook considering the beam squint phenomenon using a scheme shown in Table 7 described below. In other words, the PSMs obtained in Table 2 may be multiplied with a codebook W used in existing standards and/or a specific codebook W to be presented in a new mobile communication scheme such as 6G to create a new codebook that takes into account the beam squint phenomenon. Therefore, according to the present disclosure, the theoretical time delay values are calculated as shown in Table 1 through equations such as Equation 1, and the frequency-dependent PSMs obtained as shown in Table 2 based on Table 1 may become elements to be used in the new codebook. Hereinafter, the new codebook based on the calculated theoretical time delay values is referred to as ‘first codebook’, and the existing codebook, for example, the codebook used in the 5G mobile communication system and/or the new 6G, is referred to as ‘basic codebook matrix (W)’. The first codebook newly generated according to an embodiment of the present disclosure may be calculated as shown in Equation 4 below.

$$W {\hat{}}^{′} = W * PSM \qquad [ Equation 4 ]$$

### [Acquisition of Phase Shift Matrices (PSMs) Based on Time Delay Measurements]

In order to solve the beam squint phenomenon that occurs in a communication environment that utilizes multiple antennas and wide bandwidth, the method of calculating the time delay values through a theoretically obtained equation may be used, as described in the first embodiment. However, the method according to the first embodiment does not reflect the actual channel environment. Further, the method according to the first embodiment may only be used for antenna structures where antenna elements are installed at regular intervals, such as ULA or UPA.

Furthermore, in the case of wireless communication using the terahertz band, the channel may change sensitively depending on surrounding environments, so for more accurate communication, a process may be required in which the terminal measures the time delay values directly, and PSMs derived based on the measured time delay values are used to design a codebook.

Hereinafter, the case where the time delay values have been calculated as shown in Table 1 and Table 2 using the above-described theoretical equation may be assumed. In other words, a method of designing (or generating) frequency-dependent PSMs based on measured time delay values in addition to the frequency-dependent PSMs generated based on the calculated theoretical time delay values is described.

In the present disclosure, in order for the terminal to measure the time delay values, information on the number of panels of the base station and information for identifying the respective panels need to be shared between the base station and the terminal. In the present disclosure, a case where combinations each comprising a spatial layer and a panel mapped thereto are defined, and combination indexes are respectively assigned to the combinations in order to identify the number of spatial layers and panels may be illustrated as shown in Table 3 below.

TABLE 3

| Spatial layer | Panel | Combination index (3 bits) |
|---|---|---|
| L #1 | Panel #1 | 0 (000) |
| | Panel #2 | 1 (001) |
| | Panel #3 | 2 (010) |
| L #2 | Panel #1 | 3 (011) |
| | Panel #2 | 4 (100) |
| | Panel #3 | 5 (101) |

Table 3 shows combination indexes indicating mapping between spatial layers and antenna panels, which are used to deliver information on the spatial layers and antenna panels in a process where the base station transmitting reference signals for measurements of time delay values for the respective spatial layers and antenna panels. Information on these combination indexes and/or information on the number of spatial layers and antenna panels may be provided from the base station to the UE in advance. The base station may provide information on the combination indexes and/or information on the number of spatial layers and antenna panels to the UE through higher layer signaling and/or system information.

Meanwhile, as previously described in Table 2, the spatial layer in Table 3 may also be interpreted as an index of a beam implemented through a codebook.

After delivering information on the combination indexes for all spatial layers and antenna panels to the UE, the base station may transmit reference signals for measurement of the time delay values for the respective spatial layers and antenna panels. For example, the base station may deliver the information on the combined indexes for all spatial layers and antenna panels to the UE using higher layer signaling (e.g., RRCReconfiguration) and/or system information (e.g., system information block (SIB)). Then, the base station may transmit a reference signal for each combination index or using a channel corresponding to each combination index. Assuming that the number of available combinations is n, the number of bits to represent the combination index may be calculated as shown in Equation 5 below.

ceil(log₂n) [Equation 5]

In Equation 5, if n is 1, 1 bit is allocated, and n has a natural number of 1 or more. Therefore, if n has a value of 2 or more, the number of bits used to represent the combination index may vary according to a result of a ceiling function of Equation 5.

If the combination indexes are changed due to a certain change in the base station, the changed combination indexes may be transmitted to the UE through higher layer signaling such as RRC reconfiguration. In addition, when the UE wishes to obtain information on the changed combination indexes due to a certain change from the base station, the UE may transmit a SIB request to the base station, and the UE may receive a SIB response including the corresponding information in response to the SIB request.

Table 3 illustrates the case where the base station configures two spatial layers with three antenna panels. Accordingly, as illustrated in Table 3, a total of 6 combinations may exist. Accordingly, based on the ceiling function of Equation 5, it can be seen that the number of bits required for representing the combination index value is 3 bits.

According to an embodiment of the present disclosure, the combination index may be signaled using downlink control information (DCI) in the case of NR system when allocating resources to the UE after channel estimation for each combination is completed. Specifically, in the case of NR system, the base station may provide a combination index to the UE through a DCI format 1_1, which allocates a resource of a physical downlink shared channel (PDSCH).

Hereinafter, the reference signal according to the present disclosure is described. In the present disclosure, a time delay reference signal (TD-RS) may be newly defined to measure the time delay values. A frequency-domain density of the TD-RS according to the present disclosure may be determined according to an SCS. Table 4 shows an example of determining the frequency-domain density of the TD-RS according to the present disclosure according to an SCS.

TABLE 4

| SCS | TD-RS periodicity F_{TD-RS} (RB) |
|---|---|
| SCS #1 | F_{TD-RS} #1 (Ex. 6 RB) |
| SCS #2 | F_{TD-RS} #2 (Ex. 4 RB) |
| SCS #3 | F_{TD-RS} #3 (Ex. 3 RB) |
| SCS #4 | F_{TD-RS} #4 (Ex. 2 RB) |

Table 4 may correspond to an example for four SCSs. Taking the NR system as an example, SCS #1 may be 60 kHz, SCS #2 may be 120 kHz, SCS #3 may be 240 kHz, and SCS #4 may be 480 kHz. Alternatively, in the NR system, SCS #1 may be 120 kHz, SCS #2 may be 240 kHz, SCS #3 may be 480 kHz, and SCS #4 may be 960 kHz. In the 6G system, four or more different SCSs defined in the standard may be used. Although only the case for four SCSs is illustrated in Table 4, the same or similar method may be applied to five or more SCSs. In Table 4, the SCS may become wider as the SCS index increases. The base station may transmit information on the SCSs to the UE using a parameter subcarrierSpacing parameter included in an RRC message.

The base station may transmit the TD-RS according to the present disclosure to measure a time delay value for a channel configured to communicate with the UE or to be configured to communicate with the UE. Then, the UE may receive the TD-RS, may measure a time delay value based thereon, and may report the measured time delay value to the base station. In this case, a separate channel may be configured to report the time delay value, it may be reported through a channel state information (CSI) reporting process, or it may be reported to the base station through new RRC signaling. Here, reporting the time delay value in the CSI reporting process may include a case where the time delay value is reported as being included in a CSI report message or a case where the time delay value is transmitted through a separate message along with the CSI report message.

In Table 4, FTD-RS denotes a TD-RS transmission periodicity, and a case where the transmission periodicity becomes shorter from FTD-RS #1 to FTD-RS #4 is shown. In addition, a time delay value for a frequency resource (i.e., subcarrier) in which the TD-RS is not transmitted may be estimated at the base station using an interpolation method. For example, a time delay value for a subcarrier in which the TD-RS is not transmitted may be calculated based on an interpolation method using time delay values of the closest subcarriers among subcarriers in which the TD-RS is transmitted.

In Table 4, the reason why the TD-RS is transmitted more frequently as the SCS is larger is because as the SCS becomes larger, the frequency interval between resource elements (REs) may become wider. Therefore, in order to design more accurate PSMs, the TD-RS may need to be transmitted more frequency for each resource element to measure the time delay values more accurately. For example, in Table 4, FTD-RS for SCS #2 may be 4 RBs, which means that TD-RS is transmitted every 4 RBs.

Hereinafter, a method in which the UE receives the TD-RS, measures time delay values, and reports the measured time delay values to the base station is described. Table 5 below may be a table to describe an example of a case where the UE reports the time delay value to the base station according to the present disclosure.

TABLE 5

| Subcarrier | Layer | Panel | Time delay value |
|---|---|---|---|
| SC #12 | L #1 | Panel #1 (combination | TD, E_{12, 1, 1} |
| | | index: 0) | |
| | | Panel #2 (combination | TD, E_{12, 1, 2} |
| | | index: 1) | |
| | | Panel #3 (combination | TD, E_{12, 1, 3} |
| | | index: 2) | |
| | L #2 | Panel #1 (combination | TD, E_{12, 2, 1} |
| | | index: 3) | |
| | | Panel #2 (combination | TD, E_{12, 2, 2} |
| | | index: 4) | |
| | | Panel #3 (combination | TD, E_{12, 2, 3} |
| | | index: 5) | |
| SC #36 | L #1 | Panel #1 (combination | TD, E_{36, 1,} 1 |
| | | index: 0) | |
| | | Panel #2 (combination | TD, E_{36, 1, 2} |
| | | index: 1) | |
| | | Panel #3 (combination | TD, E_{36, 1, 3} |
| | | index: 2) | |
| | L #2 | Panel #1 (combination | TD, E_{36, 2, 1} |
| | | index: 3) | |
| | | Panel #2 (combination | TD, E_{36, 2, 2} |
| | | index: 4) | |
| | | Panel #3 (combination | TD, E_{36, 2, 3} |
| | | index: 5) | |
| . . . | . . . | . . . | . . . |
| SC #108 | L #1 | Panel #1 (combination | TD, E_{108, 1, 1} |
| | | index: 0) | |
| | | Panel #2 (combination | TD, E_{108, 1, 2} |
| | | index: 1) | |
| | | Panel #3 (combination | TD, E_{108, 1, 3} |
| | | index: 2) | |
| | L #2 | Panel #1 (combination | TD, E_{108, 2, 1} |
| | | index: 3) | |
| | | Panel #2 (combination | TD, E_{108, 2, 2} |
| | | index: 4) | |
| | | Panel #3 (combination | TD, E_{108, 2, 3} |
| | | index: 5) | |

Table 5 illustrates a case when the periodicity of TD-RS is set to 2 RBs in a situation where a total of 120 subcarriers exist in a specific frequency band that can be used for communication between the base station and the UE, the number of spatial layers of the base station is 2, and the number of antenna panels is 3.

Describing Table 5 in detail, a case is illustrated where spatial layers are respectively mapped to subcarrier indexes and antenna panels are respectively mapped to one spatial layer. This is described from the perspective of the operations of the base station and UE.

Assuming the case of SCS #4 in Table 4 described above, the base station may transmit the TD-RS every RBs for all spatial layers and antenna panels. As another example, assuming the case of SCS #1, the base station may transmit the TD-RS every 6 RBs for all spatial layers and antenna panels. In other words, the base station may determine a periodicity of TD-RS in the frequency domain through the FTD-RS value in Table 4 described above and may transmit the TD-RS based on the determined periodicity. The TD-RS transmission periodicity may be defined by a scheme of additionally transmitting the TD-RS to the UE during a CSI-RS transmission process, or information on the TD-RS transmission periodicity may be transmitted to the UE through new RRC signaling.

The UE may receive the TD-RS transmitted by the base station based on the TD-RS transmission periodicity according to the new RRC signaling or the TD-RS that is additionally transmitted in the CSI-RS transmission process. The UE may measure the time delay value based on the received TD-RS. The UE may report the measured time delay value TD, E_{x,y,z} to the base station. In this case, the time delay value measured by the UE may be a value corresponding to the combination index as shown in Table 3 described above. Describing this in more detail, when the base station wishes to allocate a specific resource as shown in Table 3, the base station may indicate the UE to report a time delay value corresponding to the resource to be allocated. Accordingly, the UE may report a delay time value for an indicated combination index based on the indication from the base station. Therefore, the UE may report the time delay values TD, E_{x,y,z} to the base station. Here, X may indicate a subcarrier index, Y may indicate a spatial layer index, and Z may indicating an antenna panel index.

The UE may use one of the methods below to report the time delay value measured for the received TD-RS.

First, the UE may transmit the measured time delay value through a CSI reporting process, and in addition, transmit (or report) information on the combination index to the base station through uplink control information (UCI).

Second, the UE may transmit (or report) information on the measured time delay value and the combination index to the base station through new RRC signaling. In other words, the UE may transmit (or report) the time delay value illustrated in Table 5 to the base station using the new RRC signaling.

The base station may receive the time delay value from the UE using one of the two methods described above. As described above, the base station may estimate a time delay value for a subcarriers in which the TD-RS is not transmitted through an interpolation method.

Meanwhile, when the base station calculates and applies a time delay value of a panel as in Equation 1 described above, if a time delay value as shown in Table 5 is received from the UE, the base station may reallocate a resource to the UE or generate a new PSM to resolve a beam squint phenomenon. Specifically, the base station may use the time delay values received from the UE and time delay values obtained through interpolation to compensate for a difference in propagation delay between antennas, and to design (alternatively, generate or update) frequency-dependent PSMs for compensating for a shift in spatial direction between subcarriers.

The matrix mapping between PSM and subcarriers may be illustrated as shown in Table 6 below.

TABLE 6

| PSM | Subcarrier | Matrix |
|---|---|---|
| PSM #1 | SC #1 | diag([exp(−j2π(SC #1) [symbol] ), |
| | | exp(−j2π(SC #1)TD, [symbol] |
| PSM #2 | SC #2 | diag(exp(−j2π(SC #2) [symbol] ), |
| | | exp(−j2π(SC #2)TD, [symbol] |
| . . . | . . . | . . . |
| PSM | SC #120 | diag([exp(−j2π(SC #120) [symbol] ), |
| #120 | | exp(−j2π(SC #1 [symbol] |

[symbol]

indicates data missing or illegible when filed

Referring to Table 6, PSM #X represents a PSM for the X-th subcarrier. The diagonal components of each matrix includes phase compensation values considering time delay values for all spatial layers and antenna panels at a frequency of the X-th subcarrier. Table 6 illustrates a case where the PSMs for all subcarriers existing with the frequency band are calculated based on different time delay values for the respective subcarriers and antenna panels, which are obtained from Table 5 described above. For example, Table 6 shows an example for a case where there are 120 subcarriers in the frequency band, and PSM #1 to PSM #120 represents PSMs for the SC #1 to SC #120. In addition, the diagonal components of PSM #X may be expressed as Equation 6 below.

$$exp ( - j 2 π ( SC \# X ) {\vec{TD , E}}_{X , Y} ) \qquad [ Equation 6 ]$$

Equation 6 expresses a phase compensation value for the X-th subcarrier(SC #X) and the Y-th spatial layer (L #Y). Therefore, SC #X refers to the X-th subcarrier in the allocated frequency band. Therefore, the time delay value for the X-th subcarrier (SC #X) and the Y-th spatial layer (L #Y) may be calculated as in Equation 7 below.

$${\vec{TD , E}}_{X , Y} = {[ TD , {E}_{X , Y , 1} TD , {E}_{X , Y , 2} … TD , {E}_{X , Y , K} ]}^{T} \qquad [ Equation 7 ]$$

In Equation 7, [·]^{T} refers to a transpose operation.

Meanwhile, in the present disclosure, because the number of antenna panels is assumed to be 3, K may be assumed to be 3.

In addition, the diagonal components of PSM #Z may include phase compensation values for the Z-th subcarrier (SC #Z) and the X-th spatial layer (L #X), which may be calculated as in Equation 8 below.

$$exp ( - j 2 π ( SC \# Z ) {\vec{TD , A}}_{X} ) \qquad [ Equation 8 ]$$

In Equation 8, the theoretical time delay values for all antenna panels corresponding to the X-th spatial layer (L #X) may be the same as Equation 3 described above.

### [Second Codebook Considering Beam Squint Phenomenon]

The method in which the base station obtains PSMs through the process described above has been described. For example, the first PSMs may be obtained using the equation. In other words, the method of obtaining the first PSMs based on Table 1 and Table 2 has been described. In addition, the second PSMs may be obtained based on the measured time delay values. In other words, the second PSMs may be obtained based on Table 3 to Table 6 described above.

The base station may use the first PSMs or seconds PSM obtained through the previous process to finally design or generate a codebook that takes the beam squint phenomenon into consideration. Furthermore, when it is determined to be difficult to use the previously obtained codebook due to a change in channel state, a process of re-measuring (and/or re-estimating) the time delay values to compensate for the beam squint phenomenon may be performed using a PSM reconstruction indicator.

The base station may obtain the codebook considering beam squint as shown in Table 7 below.

TABLE 7

| | Codebook matrix | Codebook W′ considering |
|---|---|---|
| PSM | W | beam squint |
| PSM #1 | W | W*(PSM #1) |
| PSM #2 | W | W*(PSM #2) |
| . . . | . . . | . . . |
| PSM #120 | W | W*(PSM #120) |

Referring to Table 7, in order to derive a new codebook considering the beam squint phenomenon, which is suitable for a large number of antennas and wide frequency bands, the PSMs obtained previously by the base station may be multiplied with the previously defined basic codebook matrices, for example, the existing codebook matrices defined in the NR standard or codebook matrices determined to be used in the 6G standard. Specifically, the first codebook may be generated using the first PSMs previously obtained in Table 2, or the second codebook may be generated using the second PSMs obtained in Table 6. In other words, PSM #1 to PSM #120 in Table 7 may represent PSMs for the respective subcarriers, which are obtained through Table 2 or Table 6. Taking the case of NR as an example, the basic codebook matrices may be the Type 1, Type 2, or enhanced Type 2 codebook matrices defined in the NR standard. Taking the case of 6G as an example, the basic codebook matrices may be the conventional codebook matrices generated without considering the beam squint phenomenon.

Therefore, according to the present disclosure, communication may be performed between the base station and the UE using the first codebook obtained in the manner described in Table 2. Thereafter, the codebook may be reconstructed in at least one of the two cases below.

First, the UE or base station may determine that the current codebook may not continue to be used if a received signal has an RSRP less than a preset RSRP threshold.

Second, the UE or base station may determine that the current codebook may not continue to be used when negative responses (e.g., NACK) exceeding a predetermined threshold are received in a feedback procedure (e.g., HARQ reporting procedure) for transmitted data.

The first codebook or the second codebook newly generated according to the present disclosure may be defined differently for each subcarrier. In other words, the base station (or transmitting node) according to the present disclosure may obtain PSMs for the respective subcarriers and may use them to generate the first codebook or second codebook. The base station (or transmitting node) may use the first codebook or second codebook to compensate for the difference in propagation delay between the subcarriers and the shift in spatial direction between the subcarriers, which occur in communication utilizing multiple antennas and a wide frequency band. Therefore, the base station (or transmitting node) may reduce a data error rate due to the beam squint phenomenon by communicating with the UE (or receiving node) using the first codebook or the second codebook.

Meanwhile, the base station or UE may decide whether new PSMs are needed. Based on this decision, the base station or UE may inform the other party whether new PSMs are needed.

TABLE 8

| PSM reconstruction indicator | PSM reconstruction information |
|---|---|
| 0 | New PSMs do not need to be designed |
| 1 | New PSMs need to be designed |

Table 8 shows an example of setting a PSM reconstruction indicator according to a channel environment between the UE and the base station according to the present disclosure. Based on an RSRP threshold set by the base station, the UE may determine that the codebook currently in use cannot continue to be used when an RSRP of a received signal does not exceed the threshold.

The RSRP threshold according to the present disclosure may be set by the base station through RRC measurement configuration, i.e., MeasConfig of RRCReconfiguration. If the UE determines that it cannot continue to use the codebook currently used by the base station, the UE may transmit information requesting design of new PSMs to the base station because a process of designing new PSMs is necessary before generating a new codebook.

As another example, the UE may determine that the UE cannot continue to use the codebook the UE is currently using if more than a predetermined number of NACKs are reported as HARQ feedbacks based on a specific transmission rate.

The information requesting design of new PSMs may be transmitted through a PSM reconstruction indicator, and the PSM reconstruction indicator may be transmitted to the base station through UCI, through UEInformationRequest/Response or UE Assistance Information, or through another new RRC signaling. For example, whether to redesign PSMs may be specified within an RRC signaling message in a form below.

Enumerated {True, False}, Enumerated {Needed, Not Needed}

In other words, if a specific IE is indicated as ‘True’ or ‘Required’, it may indicate that it is required to redesign (or generate) new PSMs. Conversely, if the IE is indicated as ‘False’ or ‘Not Needed’, it may indicate that it is not required to redesign (or generate) new PSMs.

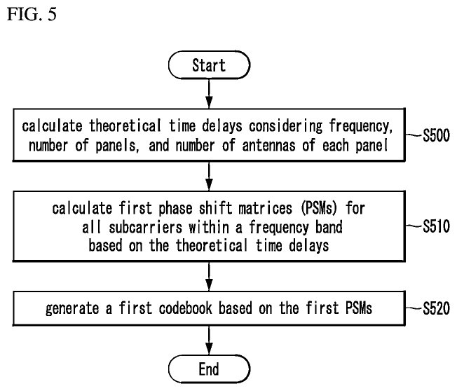

FIG. 5 is a control flow diagram for a case of generating the first codebook according to an embodiment of the present disclosure.

Before referring to FIG. 5, it should be noted that the control flow diagram of FIG. 5 represents operations performed at a transmitting node, and for convenience of description, the operations is described as being assumed to be performed at a base station.

In step S500, the base station may calculate theoretical time delays by considering frequencies, such as the number of subcarriers that can be used in a specific band, the number of panels used by the base station for communication, and the number of antenna elements in each panel. The calculated time delay values may consider spatial layers together as described above in Table 1. Therefore, the time delay values may be calculated as shown in Table 1. Specifically, the time delay values may be calculated as shown in Equation 1 described above.

In step S510, the base station may calculate the first PSMs for all subcarriers within the frequency band based on the theoretical time delay values. The calculation of the first PSMs may be performed as described in Table 2 above.

In step S520, the base station may generate the first codebook based on the first PSMs. The first codebook may be generated based on the method described in Equation 4 or Table 7 above. In other words, the first codebook may be generated by multiplying the basic codebook matrices not considering the beam squint phenomenon with the first PSMs.

After generating the first codebook as described above, the base station may communicate with the UE while compensating for the beam squint phenomenon based on the first codebook. Therefore, when using the first codebook, data can be transmitted more reliably compared to the case of using the existing codebook that does not consider the beam squint phenomenon. Accordingly, the number of retransmissions for data transmission can be reduced, and data can be obtained more reliably at a receiving node.

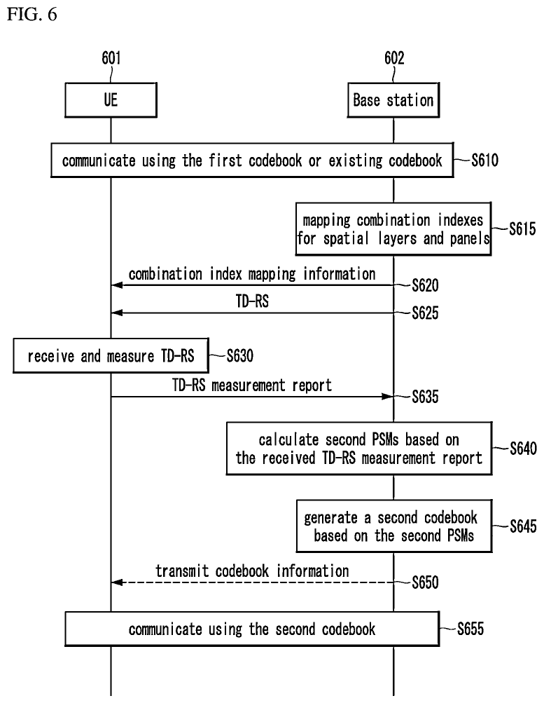

FIG. 6 is a control flow diagram for a case of generating the second codebook according to another embodiment of the present disclosure.

Referring to FIG. 6, a UE 601 is assumed to be a receiving node, and a base station 602 is assumed to be a transmitted node. However, as described above, if the transmitting node is a UE, the receiving node may be a base station or another second UE. Hereinafter, for convenience of describing, it is assumed that the UE 601 is a receiving node and the base station 602 is a transmitting node.

In step S610, the UE 601 and the base station 602 may communicate using the existing codebook, for example, the Type 1 codebook, Type 2 codebook, or enhanced Type 2 codebook according to the NR standard. As another example, the UE 601 and the base station 602 may communicate based on a new 6G codebook that does not consider the beam squint phenomenon. As another example, the UE 601 and the base station 602 may communicate using the first codebook previously obtained through the process of FIG. 5.

In step S615, the base station 602 may define combination indexes for spatial layers and antenna panels. Step S615 may be performed during initial communication using the existing codebook or during communication using the first codebook. Alternatively, the case of proceeding to step S615 may be one of the cases described previously in Table 8. For example, this may be the case when a PSM reconstruction indicator is received from the UE 601. In step S615, the combination indexes for the spatial layers and the antenna panels may be mapped in the same manner as previously described in Table 3.

In step S620, the base station 602 may transmit information on the combinations of antenna panels and spatial layers (i.e., combination index mapping information) to the UE 601. As described above, the information on the combinations for the antenna panels and the spatial layers may be transmitted to the UE 601 using higher layer signaling, for example, RRCReconfiguration and/or SIB. Accordingly, the UE 601 may receive and store the combination index mapping information transmitted in step S620. The combination index mapping information may be stored in the memory 220 or the storage device 260.

In step S625, the base station 602 may transmit TD-RSs to the UE 601. The TD-RS may be a reference signal according to the present disclosure, and a frequency-domain density therefor may vary depending on an SCS, as previously described in Table 4.

In step S630, the UE 601 may receive the TD-RSs from the base station 602 and may measure the received TD-RSs to calculate (or measure) time delay values. As previously described in Table 5, the time delay values may be calculated in accordance with combinations of subcarriers, spatial layers, and antenna panels.

In step S635, the UE 601 may transmit a TD-RS measurement report to the base station 602 based on the time delay values measured or calculated based on the TD-RSs. Here, the time delay values measured based on the TD-RSs may be reported using a CSI reporting process or through new RRC signaling.

In step S640, the base station 602 may calculate the second PSMs based on the received TD-RS measurement report. The second PSMs may be generated for the respective subcarriers. The second PSMs may include phase compensation values for the respective subcarriers and the spatial layers through which the corresponding subcarriers are transmitted.

In step S645, the base station 602 may generate the second codebook using the second PSMs generated for the respective subcarriers. The second codebook may be generated as shown in Equation 4 or Table 7 described above. In other words, the second codebook matrix may be generated by multiplying the basic codebook matrix by the second PSM.

In step S650, the base station 602 may transmit information on the second codebook to the UE 601 when necessary. When the base station 602 transmits the information on the second codebook to the UE 601, if it is applicable to uplink, the second codebook may be converted into a form applicable to the UE 601 or information used to convert the second codebook may be further transmitted. If the base station 602 does not need to transmit the information on the second codebook to the UE 601, step S650 may not be performed.

When the second codebook is generated or information on the second codebook is shared between the base station 602 and the UE 601, communication may be performed between the base station 602 and the UE 601 using the second codebook in step S655.

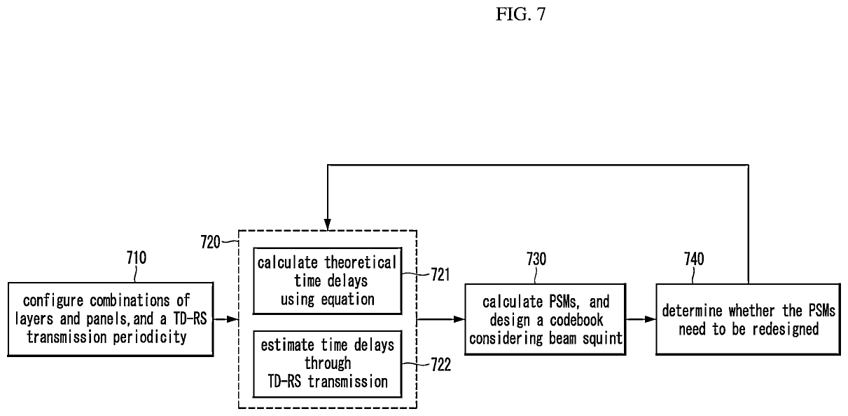

FIG. 7 is a conceptual diagram illustrating a procedure for generating a codebook considering beam squint phenomenon and communicating using the codebook in a wireless communication system according to an embodiment of the present disclosure.

As shown in FIG. 7, a transmitting node may configure combinations of layers and panels and a TD-RS transmission periodicity in step 710. Here, the layer may mean a spatial layer. Therefore, the combinations of layers and panels may be configured based on the method described in Table 3. The TD-RS transmission periodicity may be determined according to an SCS based on Table 4 described above. Therefore, in step 710, the transmitting node may configure the combinations of spatial layer and panel based on Table 3 and may determine the periodicity and density of TD-RS based on Table 4.

The transmitting node may calculate or estimate time delay values in step 720. In case of using the first codebook described above, the transmitting node may calculate the theoretical time delay values based on a predetermined equation as in step 721, for example, the method described in Table 1 and Table 2. Alternatively, in case of using the second codebook, the base station may transmit TD-RSs to the receiving node as in step 722 and may receive time delay values reported from the receiving node. Additionally or alternatively, the transmitting node may obtain the time delay values using the time delay values estimated by applying an interpolation scheme on the time delay values reported from the receiving node.

If the theoretical time delay values are calculated as in step 721 and/or if the time delay values are obtained by applying an interpolation technique on the time delay values reported from the receiving node as in step 722, the transmitting node may perform step 730.

In step 730, the transmitting node may calculate PSMs using the values obtained in step 721 and/or the values obtained in step 722 and may design (or generate or obtain) a codebook considering the beam squint phenomenon. If the codebook considering beam squint phenomenon is designed (or generated or obtained) using the values obtained in step 721, the first codebook described above may be generated. On the other hand, if the codebook considering beam squint phenomenon is designed (or generated or obtained) using the values obtained in step 722, the second codebook described above may be generated.

If the first codebook or the second codebook is designed (or generated or acquired) in step 730, communication between the transmitting node and the receiving node may be performed using the first or second codebook.

Meanwhile, in step 740, the receiving node or the transmitting node may determine whether redesign of PSMs is required. The redesign of PSMs may be required when a channel condition changes rapidly. For example, the redesign of PSMs may be required when an RSRP for a reference signal received from the transmitting node falls below a preset threshold at the receiving node or when NACKs are transmitted or received as HARQ feedbacks more than a predetermined number of times within a predetermined time. If the receiving node determines that redesign of PSMs is required, the receiving node may transmit a codebook reconstruction indicator (i.e., PSM reconstruction indicator) as shown in Table 8 to the transmitting node. On the other hand, if the transmitting node determines that redesign of PSMs is required, the transmitting node may notify that reconstruction of the codebook is required by providing a codebook reconstruction indicator in step 720. Upon receiving the codebook reconstruction indicator, step 720, for example, step 722, may be re-performed.

Specifically, to perform step 722, the TD-RS described above in FIG. 6 may be transmitted, and when a TD-RS measurement report is received from the receiving node, the second PSMs may be regenerated based on the received TD-RS measurement report.

The operations of the method according to the embodiment of the present disclosure can be implemented as a computer readable program or code in a computer readable recording medium. The computer readable recording medium may include all kinds of recording apparatus for storing data, which can be read by a computer system. Furthermore, the computer readable recording medium may store and execute programs or codes, which can be distributed in computer systems connected through a network and read through computers in a distributed manner.

The computer readable recording medium may include a hardware apparatus, which is specifically configured to store and execute a program command, such as a ROM, RAM or flash memory. The program command may include not only machine language codes created by a compiler but also high-level language codes, which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some embodiments, a programmable logic device such as a field-programmable gate array may be used to perform some or all of functions of the methods described herein. In some embodiments, the field-programmable gate array may be operated with a microprocessor to perform one of the methods described herein. In general, the methods are desirably performed by a certain hardware device.

The description of the present disclosure is merely illustrative in nature, and, thus variations that do not depart from the substance of the disclosure are intended to be within the scope of the disclosure. Such variations should not be regarded as a departure from the spirit and scope of the present disclosure. Thus, it should be understood by those of ordinary skill in the art that various changes in form and details may be made without departing from the spirit and scope as defined by the following claims.

What is claimed is:

1. A method of a first communication node, the method comprising:
based on a number of antenna panels, a number of antennas in each antenna panel, and spatial layers configurable using a plurality of antennas, calculating time delay values based on a carrier frequency;
generating first frequency-dependent phase shift matrices (PSMs) for respective subcarriers using the calculated time delay values; and
generating a first codebook compensating for a beam squint phenomenon of beams generated by the plurality of antennas by multiplying matrices of a basic codebook with the first PSMs.

2. The method according to claim 1, wherein the first PSM includes a phase compensation value for each spatial layer transmitted for each subcarrier.

3. The method according to claim 1, wherein the basic codebook is one of codebooks generated without considering the beam squint phenomenon.

4. The method according to claim 1, wherein each of the antenna panels has a Uniform Linear Array (ULA) structure or a Uniform Planar Array (UPA) structure.

5. A method of a first communication node, the method comprising:
mapping combination indexes to antenna panels and spatial layers configurable using a plurality of antennas;
transmitting mapping information for the combination indexes to a second communication node;
transmitting a time delay reference signal (TD-RS) to the second communication node based on a frequency-domain density according to a subcarrier spacing (SCS);
receiving time delay values for respective subcarriers, which are respectively mapped to the spatial layers and the antenna panels, from the second communication node;
generating second frequency-dependent second phase shift matrices (PSMs) based on the received time delay values; and
generating a second codebook compensating for a beam squint phenomenon of beams generated by the plurality of antennas by multiplying matrices of a basic codebook with the second PSMs.

6. The method according to claim 5, wherein the second PSM includes a phase compensation value for each spatial layer transmitted for each subcarrier.

7. The method according to claim 5, wherein the basic codebook is one of codebooks generated without considering beam squint phenomenon.

8. The method according to claim 5, wherein the mapping information for the combination indexes for the spatial layers and the antenna panels is transmitted to the second communication node through higher layer signaling or a system information block (SIB).

9. The method according to claim 5, wherein the time delay values are received as being included in a channel state information (CSI) report.

10. The method according to claim 5, wherein in the generating of the frequency-dependent second PSMs, a time delay value for a subcarrier in which the TD-RS is not transmitted is calculated based on interpolation using time delay values of closest subcarriers among subcarriers in which the TD-RS is transmitted.

11. The method according to claim 5, further comprising: transmitting data to the second communication node using the second codebook.

12. The method according to claim 11, further comprising:
transmitting the TD-RS to the second communication node when re-generation of the second PSMs is requested from the second communication node;
re-receiving time delay values for the respective subcarriers, which respectively are mapped to the spatial layers and the antenna panels, from the second communication node;
re-generating frequency-dependent second PSMs based on the re-received time delay values; and
re-generating a second codebook using the re-generated second PSMs.

13. A first communication node comprising at least one processor, wherein the at least one processor causes the first communication node to perform:
mapping combination indexes to antenna panels and spatial layers configurable using a plurality of antennas, and transmitting mapping information for the combination indexes to a second communication node;
transmitting a time delay reference signal (TD-RS) to the second communication node based on a frequency-domain density according to a subcarrier spacing (SCS);
receiving time delay values for respective subcarriers, which are respectively mapped to the spatial layers and the antenna panels, from the second communication node;
generating second frequency-dependent second phase shift matrices (PSMs) based on the received time delay values; and
generating a second codebook compensating for a beam squint phenomenon of beams generated by the plurality of antennas by multiplying matrices of a basic codebook with the second PSMs.

14. The first communication node according to claim 13, wherein the second PSM includes a phase compensation value for each spatial layer transmitted for each subcarrier.

15. The first communication node according to claim 13, wherein the basic codebook is one of codebooks generated without considering beam squint phenomenon.

16. The first communication node according to claim 13, wherein the mapping information for the combination indexes for the spatial layers and the antenna panels is transmitted to the second communication node through higher layer signaling or a system information block (SIB).

17. The first communication node according to claim 13, wherein the time delay values are received as being included in a channel state information (CSI) report.

18. The first communication node according to claim 13, wherein in the generating of the frequency-dependent second PSMs, the processor causes the first communication node to perform: calculating a time delay value for a subcarrier in which the TD-RS is not transmitted based on interpolation using time delay values of closest subcarriers among subcarriers in which the TD-RS is transmitted.

19. The first communication node according to claim 13, wherein the processor further causes the first communication node to perform: transmitting data to the second communication node using the second codebook.

20. The first communication node according to claim 19, wherein the processor further causes the first communication node to perform:
transmitting the TD-RS to the second communication node when re-generation of the second PSMs is requested from the second communication node;
re-receiving time delay values for the respective subcarriers, which respectively are mapped to the spatial layers and the antenna panels, from the second communication node;
re-generating frequency-dependent second PSMs based on the re-received time delay values; and
re-generating a second codebook using the re-generated second PSMs.
